(19) United States
(12) Patent Application Publication
(10) Pub. No.: US 2025/0088740 A1
(43) Pub. Date: Mar. 13, 2025

(54) ELECTRONIC DEVICE AND METHOD FOR TAKING PICTURE THEREOF

(71) Applicant: STUDIO LAB CO., LTD, Seoul (KR)

(72) Inventors: Sung Hoon KANG, Seoul (KR); Jae Young LEE, Seongnam-si Gyeonggi-do (KR)

(73) Assignee: STUDIO LAB CO., LTD, Seoul (KR)

(21) Appl. No.: 18/959,988

(22) Filed: Nov. 26, 2024

Related U.S. Application Data
(63) Continuation of application No. PCT/KR2023/015539, filed on Oct. 10, 2023.

(30) Foreign Application Priority Data
Oct. 12, 2022 (KR) 10-2022-0130235

(51) Int. Cl. H04N 23/667; B25J 9/16; G06T 7/50; G06T 7/73; H04N 23/611

(52) U.S. Cl. CPC H04N 23/667; B25J 9/1697; G06T 7/50; G06T 7/73; H04N 23/611

(57) ABSTRACT

A method for taking a picture according to an embodiment may include a step of acquiring a first image of a subject, a step of determining a background and a composition based on the first image, and a step of acquiring a second image of the subject by taking a picture of the subject with the background and the composition.

### CROSS-REFERENCE TO RELATED APPLICATIONS

This application is a continuation of International Application No. PCT/KR2023/015539 filed on Oct. 10, 2023, which claims priority to Korean Patent Application No. 10-2022-0130235 filed on Oct. 12, 2022, the entire contents of which are herein incorporated by reference.

### TECHNICAL FIELD

The present disclosure relates to an electronic device and a method for taking a picture thereof.

### BACKGROUND ART

When uploading information of a product to be sold to a server, various methods are used to take a picture of the product. Among the methods, a method for taking a picture of the product in a booth-shaped space by using a fixed camera has been commonly used. However, this method has a problem in that since the movement of the camera is limited, the background and composition are limited due to shooting in the limited space, and program operation is required, it is inconvenient for a shopping mall seller with low IT proficiency and post-picture processing and product registration need to be additionally performed because only taking pictures is possible.

### SUMMARY

### Technical Problem

The present disclosure is directed to suggesting various studio backgrounds and compositions, and providing an electronic device enabling high-quality shooting and a method for taking a picture thereof.

The present disclosure is directed to providing an electronic device that implements the movement of photographer with an automatic shooting solution requiring no separate operation and a method for taking a picture thereof.

The present disclosure is directed to providing an electronic device linked with a service for correcting a picture after shooting and automatically producing a product detail page and a method for taking a picture thereof.

### Technical Solution

In order to achieve the objects, a method for taking a picture according to an embodiment may include: a step of acquiring a first image of a subject; a step of determining a background and a composition based on the first image; and a step of acquiring a second image of the subject by taking a picture of the subject with the background and the composition.

The method for taking a picture may further include a step of acquiring a shooting mode, wherein the step of acquiring the first image may include a step of acquiring the first image according to the shooting mode, the step of acquiring the second image may include a step of acquiring the second image according to the shooting mode, and the shooting mode may be any one of a fashion clothing shooting mode, a product shooting mode, a profile photo shooting mode, an ID photo shooting mode, and a background photo shooting mode.

The step of determining the background and the composition may include: a step of extracting a feature of the first image; and a step of determining a background and a composition corresponding to the feature of the first image from a database.

The step of determining the background and the composition may include: a step of acquiring a plurality of images from the database; a step of acquiring backgrounds and compositions of the plurality of images; a step of training an artificial neural model by using the plurality of images and the backgrounds and compositions of the plurality of images as a training set; and a step in which the artificial neural model determines the background and the composition based on the first image.

The step of determining the background and the composition may include: a step of extracting a feature of the first image; and a step of determining a position and a proportion of the subject in the image from the database based on the feature of the first image.

The method for taking a picture may further include a step of determining a pose based on the first image when the first image includes a person.

The step of determining the pose may include: a step of acquiring a body shape of the person based on the first image; and a step of determining a pose corresponding to the body shape.

The method for taking a picture may further include: a step of determining a similarity between the person and the pose; and a step of taking a picture of the subject when the similarity exceeds a reference value and outputting a notification message when the similarity is below the reference value.

The method for taking a picture may further include: a step of extracting a feature of the second image; and a step of generating a page based on the feature of the second image.

An electronic device according to an embodiment may include: an image sensor configured to acquire a first image of a subject; and a processor configured to determine a background and a composition based on the first image, wherein the image sensor may be further configured to acquire a second image of the subject by taking a picture of the subject with the background and the composition.

The electronic device may further include a robot arm disposed with the image sensor and driven according to a command of the processor, wherein the processor may perform training by using an image taken by a specific photographer, a composition, a shooting position, and a distance to the subject as a training data set, and control the robot arm to take an image with the composition and the shooting position of the specific photographer and the distance to the subject when a specific photographer mode is input.

The processor may perform training by using the image taken by the specific photographer and an image setting value as the training data set, and edit the first image and the second image by applying the image setting value.

The processor may be further configured to acquire a shooting mode, the image sensor may be further configured to acquire the first image according to the shooting mode and acquire the second image according to the shooting mode, and the shooting mode may be any one of a fashion clothing shooting mode, a product shooting mode, a profile photo shooting mode, an ID photo shooting mode, and a background photo shooting mode.

The processor may be further configured to extract a feature of the first image and determine a background and a composition corresponding to the feature of the first image from a database.

The processor may be further configured to acquire a plurality of images from the database, acquire backgrounds and compositions of the plurality of images, train an artificial neural model by using the plurality of images and the backgrounds and compositions of the plurality of images as a training set, and allow the artificial neural model to determine the background and the composition based on the first image.

The electronic device may further include a moving part driven according to a command of the processor, wherein the processor may be further configured to determine a similarity between the subject and the background and the composition of the trained image, take a picture of the subject when the similarity exceeds a reference value, and instruct the moving part to move when the similarity is below the reference value.

The processor may be further configured to extract a feature of the first image and determine a position and a proportion of the subject in the image from a database based on the feature of the first image.

The processor may be further configured to determine a pose based on the first image when the first image includes a person.

The processor may be further configured to acquire a body shape of the person based on the first image and determine a pose corresponding to the body shape.

The processor may be further configured to determine a similarity between the person and the pose, take a picture of the subject when the similarity exceeds a reference value, and output a notification message when the similarity is below the reference value.

The processor may be further configured to extract a feature of the second image and generate a page based on the feature of the second image.

### Advantageous Effects

A method for taking a picture according to an embodiment enables shooting with a background and composition optimized for a product.

A method for taking a picture according to an embodiment enables shooting of a product without spatial constraints by using a movable robot.

A method for taking a picture according to an embodiment enables shooting of a product at various angles and compositions by imitating the movement of a professional photographer by using an articulated robot having two or more axes.

A method for taking a picture according to an embodiment provides various pose guides to a subject, thereby enabling beginner model to be taken like a professional model.

A method for taking a picture according to an embodiment allows each shopping mall to achieve optimized, standardized, or consistent pictures for product sales by securing photos absolutely necessary when taking a picture of a product.

A method for taking a picture according to an embodiment shortens time for producing a product page by correcting taken pictures and uploading the corrected pictures to a server.

### DESCRIPTION OF DRAWINGS

FIG. 1 is a schematic block diagram of an electronic system according to an embodiment.

FIG. 2 is a schematic block diagram of an electronic device according to an embodiment.

FIG. 3 is a diagram for explaining the operation of an electronic device according to an embodiment.

FIG. 4 is an example of a screen output by an electronic device according to an embodiment.

FIG. 5 is a flowchart for explaining the operation of an electronic device according to an embodiment.

FIG. 6 is a diagram for explaining the operation of a controller according to an embodiment.

FIG. 7 is an example of an image input to a controller according to an embodiment.

FIG. 8 is an example of an optimal page output by a controller according to an embodiment.

FIG. 9 is an example of an edit page output by a controller according to an embodiment.

FIG. 10 is an example of an edit page output by a controller according to an embodiment.

FIG. 11 is a flowchart of a page output method according to an embodiment.

FIG. 12 is a flowchart of a page output method according to an embodiment.

FIG. 13 is a flowchart of a page output method according to an embodiment.

FIG. 14 is a diagram for explaining the operation of a controller according to an embodiment.

FIG. 15 is a flowchart of a page output method according to an embodiment.

### DETAILED DESCRIPTION

Hereinafter, with reference to the attached drawings, embodiments of the present disclosure are described in detail so that those skilled in the art to which the present disclosure pertains can easily carry out the present disclosure. However, the present disclosure can be implemented in various different forms and is not limited to the embodiments described herein.

In addition, in order to clearly describe the present disclosure in the drawings, parts that are not related to the description have been omitted, and similar parts have been given similar reference numerals throughout the specification. In flowcharts described with reference to the drawings, the order of operations may be changed, several operations may be merged, some operations may be divided, and specific operations may not be performed.

In addition, expressions described in the singular may be interpreted as singular or plural unless explicit expressions such as “one” or “single” are used. Terms including ordinal numbers such as first and second may be used to describe various components, but the components are not limited by these terms. These terms may be used for the purpose of distinguishing one component from another component.

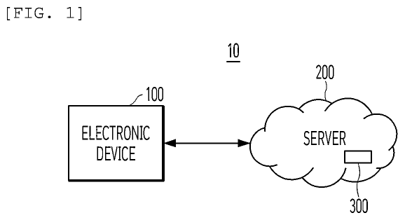

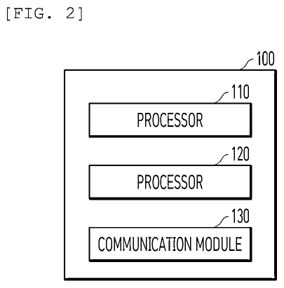

FIG. 1 is a schematic block diagram of an electronic system according to an embodiment, and FIG. 2 is a schematic block diagram of the electronic device according to an embodiment.

Referring to FIGS. 1 and 2, an electronic system 10 includes an electronic device 100 and a server 200. In the electronic system 10, the electronic device 100 and the server 200 may communicate with each other. The server 200 may provide services to a plurality of tenants. The server 200 may manage the plurality of tenants as customers. Each of the plurality of tenants may correspond to each of a plurality of users. For example, a first tenant among the plurality of tenants may access the server 200 by using the electronic device 100 and use the functions of the server 200.

The electronic device 100 may take an image and upload the image to the server 200. In addition, the electronic device 100 may operate by receiving commands and/or data from the server 200.

The electronic device 100 may include a processor 110, an image sensor 120, and a communication module 130.

The processor 110 may control the operation of the electronic device 100. For example, the processor 110 may operate based on a command from the server 200, operate based on a command from a user, or operate based on a predetermined rule.

The image sensor 120 may take a picture of a subject based on a command from the processor 110. For example, the subject may be a background, a person, a product, and the like. When the subject is a person, the processor 110 may instruct the subject on a location, a pose, an expression, props, and the like. The image sensor 120 may transmit the taken image to the processor 110.

The processor 110 may acquire a shooting mode and adjust parameters of the image sensor 120 according to the shooting mode. The shooting mode may be a fashion clothing shooting mode, a product shooting mode, a profile photo shooting mode, an ID photo shooting mode, a background photo shooting mode, and the like. The parameters of the image sensor 120 may include ISO sensitivity, shutter speed, exposure value (EV), focus, white balance (WB), and the like.

The processor 110 may use a crawling function. The crawling function may mean a function of collecting websites, hyperlinks, data, information resources, and the like. The processor 110 may assign an identifier to each piece of data collected from the server 200 and store the data in a database.

The processor 110 may search the database for an image similar to an image acquired from the image sensor 120. The processor 110 may acquire a composition and a pose from at least one searched image. The processor 110 may provide the acquired composition and pose to the user.

The processor 110 may suggest a composition and a pose to the subject. For example, the processor 110 may determine a composition and a pose suitable for the subject based on the body shape, environment, objects, and the like of the subject.

In an embodiment, the processor 110 may acquire and analyze the body shape of the subject, and determine a composition and a pose based on the body shape of the subject. The processor 110 may provide the determined composition and pose to the user. For example, the processor 110 may provide information to the user through components such as a voice module and a display, or transmit the information to an electronic device of the user.

The processor 110 may determine whether the subject takes the provided pose for a predetermined time. The processor 110 may determine the similarity between the pose of the subject and the provided pose. When the similarity exceeds a reference value, the processor 110 may take a picture of the subject by using the image sensor 120. When the similarity is below the reference value, the processor 110 may output a notification message. The notification message may be a message instructing the subject to take the provided pose.

The processor 110 may adjust the parameters of the image sensor 120 according to the environment of a shooting site. The environment of the shooting site may include whether the shooting site is indoor/outdoor, underground/above ground, outdoor weather, the amount of sunlight, illuminance, wind direction, wind speed, and the like. The processor 110 may adjust the parameters of the image sensor 120 in order to acquire an image appropriate for the environment.

The processor 110 may acquire information on an object in the shooting site. For example, the processor 110 may acquire information on what the object is, what color it has, what the location coordinates are, and the like. The processor 110 may recommend a composition and a pose based on the information on the object.

In the above, the processor 110 of the electronic device 100 is described as directly performing operations such as training and recommendation, including an artificial intelligence (AI) model; however, the present disclosure is not limited thereto and a controller 300 of the server 200 may perform these operations and transmit operations results to the processor 110.

As needed, the electronic device 100 may be implemented as further including a robot arm, a moving part, a display, a lighting device, a voice module, a storage device, and the like. Such components may be driven according to the command of the processor 110.

For example, the robot arm may be a component for moving the position of the image sensor 120. The moving part may be a component for moving the position of the electronic device 100. The processor 110 may analyze the position of the subject in the overall composition of the photo, and when the analyzed position of the subject does not match the previously learned photo guideline, the processor 110 may control the moving part in order to adjust a distance from the subject. The display may be a component for providing an interface for the user to operate the electronic device 100. The lighting device may be a component for adjusting the illumination when shooting. The voice module may include a microphone and/or a speaker and may be a component for operating by recognizing the user's voice and or providing information to the user. The storage device may be a component for storing the processing of the processor 110.

The processor 110 may communicate with the server 200 by using the communication module 130. The communication module 130 and the server 200 may communicate with each other by using a network. For example, the network includes, but is not limited to, RF, a 3rd generation partnership project (3GPP) network, a long term evolution (LTE) network, a 5th generation partnership project (5GPP) network, a world Interoperability for microwave access (WIMAX) network, the Internet, a local area network (LAN), a wireless local area network (WLAN), a wide area network (WAN), a personal area network (PAN), a value added network (VAN), a Bluetooth network, a NFC network, a satellite broadcasting network, an analog broadcasting network, a digital multimedia broadcasting (DMB) network, and the like. The processor 110 may upload data to the server 200 or receive data from the server 200.

When the processor 110 uploads the taken image to the server 200, the controller 300 of the server 200 may generate a page for describing the image based on the received image. For example, when the image uploaded by the processor 110 is an image of a product, the controller 300 may generate a detailed page about the product.

The controller 300 may be implemented as a computational module such as a central processing unit (CPU), a graphics programming unit (GPU), a neural processing unit (NPU), and a tensor processing unit (TPU). The controller 300 may include an artificial intelligence model having an artificial neural network. The artificial intelligence model may be learned to generate an optimal page from input data. The input data may be data such as an image, user information, and environmental information. The optimal page may mean a page in which images, text, designs, and the like are optimized for the user. The controller 300 may train the artificial neural network by using the input data and the generated optimal page as training data.

The controller 300 may receive images and/or information data from the electronic device 100. The images may include photos, moving pictures, and the like. The moving pictures may include continuous images taken by a camera and images generated by connecting together a plurality of non-continuous photos.

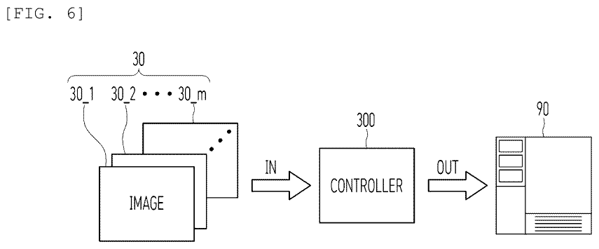

In an embodiment, when an image is received, the controller 300 may generate an optimal page by extracting features from the image, generating a design, generating text, and editing the image. The controller 300 may output the optimal page to the electronic device 100. The configuration for the controller 300 to generate the optimal page from an image is described below with reference to FIGS. 6 to 13.

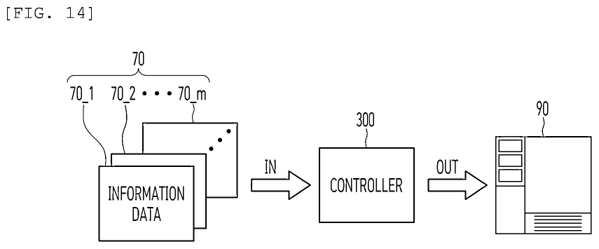

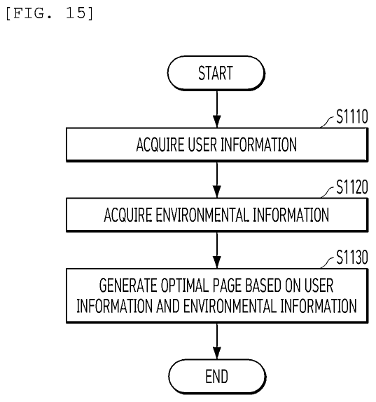

In an embodiment, when information data is received, the controller 300 may generate an optimal page based on the information data. For example, the information data may include user information and/or environmental information. Depending on the embodiment, the user information and/or the environmental information may have been stored in a database (DB). The controller 300 may output the optimal page to the electronic device 100. The configuration for the controller 300 to generate the optimal page from information data is described below with reference to FIGS. 14 and 15.

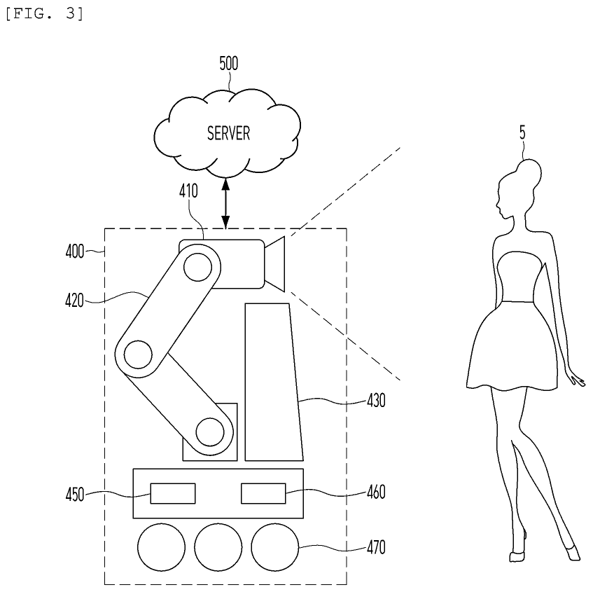

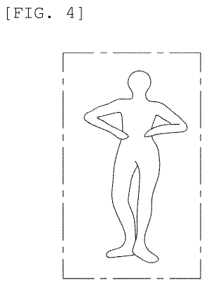

FIG. 3 is a diagram for explaining the operation of an electronic device according to an embodiment, and FIG. 4 is an example of a screen output by the electronic device according to an embodiment.

Referring to FIG. 3, an electronic device 400 according to an embodiment may acquire an image by taking a picture of a subject 5 and upload the image to a server 500.

In FIG. 3, the subject 5 is illustrated as a model, but is not limited thereto, and the subject 5 may be implemented as an object, a background, and the like.

The electronic device 400 may include an image sensor 410, a robot arm 420, a display 430, a processor 450, a communication module 460, a moving part 470, and lighting (not illustrated).

The image sensor 410 may be a shooting component arranged on the robot arm 420. For example, the image sensor 410 may be implemented as a complementary metal-oxide semiconductor (CMOS), a lens, a digital single lens reflex (DSLR), a smart phone, and the like. The image sensor 410 may perform the same operation as the image sensor 120 described with reference to FIGS. 1 and 2.

The robot arm 420 may be driven according to a command of the processor 450 and may produce various compositions for taking a picture of the subject 5. For example, the robot arm 420 may be implemented as a manipulator. The manipulator may have 6 axes, 7 axes, and the like, or may be of up-down type, left-right type, up-down-left-right type, or fixed type.

The processor 450 may learn the movement of a photographer and control the robot arm 420 to move like the photographer. For example, the processor 450 may perform training by using images, compositions, shooting locations, distances from the subject, and the like as training data sets. Each photographer may take pictures with different compositions, locations, distances, and the like. That is, the processor 450 may store information on different compositions, locations, distances, and the like for each photographer. When a command to take a picture in a specific photographer mode is received, the processor 450 may command the robot arm 420 to imitate the movement of a specific photographer.

The display 430 may output a composition and a pose to the subject 5 according to the command of the processor 450. The processor 450 may provide a pose guide through the display 430 so that the subject 5 may take a pose. The pose guide according to an embodiment may be as illustrated in FIG. 4.

The processor 450 may determine the similarity between the pose of the subject 5 and the pose guide. When the similarity between the pose of the subject 5 and the pose guide exceeds a reference value, the processor 450 may take a picture by using the image sensor 410. When the similarity is below the reference value, the processor 450 may output a notification message. The notification message may be a message instructing the subject to take a provided pose. The processor 450 may visually output the message through the display 430 or may audibly output the message by using a voice module. Alternatively, the processor 450 may transmit the message to an electronic device of a user. The user may be an entity who operates the electronic device 400 or the subject 5.

The processor 450 may perform the same operation as that of the processor 110 described with reference to FIGS. 1 and 2.

The communication module 460 may communicate with the server 500 according to the command of the processor 450. The communication module 460 may upload the taken image to the server 500 or receive a command and/or data from the server 500. For example, the server 500 may instruct the processor 450 on a shooting composition and a pose through the communication module 460. In such a case, the processor 450 may output the composition and pose to the display 430 according to an instruction of the server 500. The communication module 460 may perform the same operation as that of the communication module 130 described with reference to FIGS. 1 and 2.

The moving part 470 may support the robot arm 420. The moving part 470 may include wheels and move the electronic device 400. The moving part 470 may move along a set path or freely move toward set coordinates according to the command of the processor 450. When the moving part 470 moves along a set path, a rail may be installed on the floor, and the moving part 470 may be implemented by moving on the rail. When the moving part 470 moves according to the command of the processor 450, the moving part 470 may further include a driving motor for rotating the wheels according to the command of the processor 450.

The lighting may be located within the electronic device 400 or configured as a separately movable form (a motor-driven form, a drone, and being installed in a studio), and various embodiments are possible so that the form of the lighting is linked with the electronic device 400 to enable shooting together. The lighting may be linked with the electronic device 400 to adjust the illuminance, or may be positioned in consideration of the mood of an entire image and the shape of a shadow, and may emit light. For example, the processor 450 of the electronic device 400 may analyze the shadow and mood of a learned photographic image, the brightness of the photo, and the like, and control the position of the lighting and/or the amount of light according to the analyzed shadow, mood, and brightness.

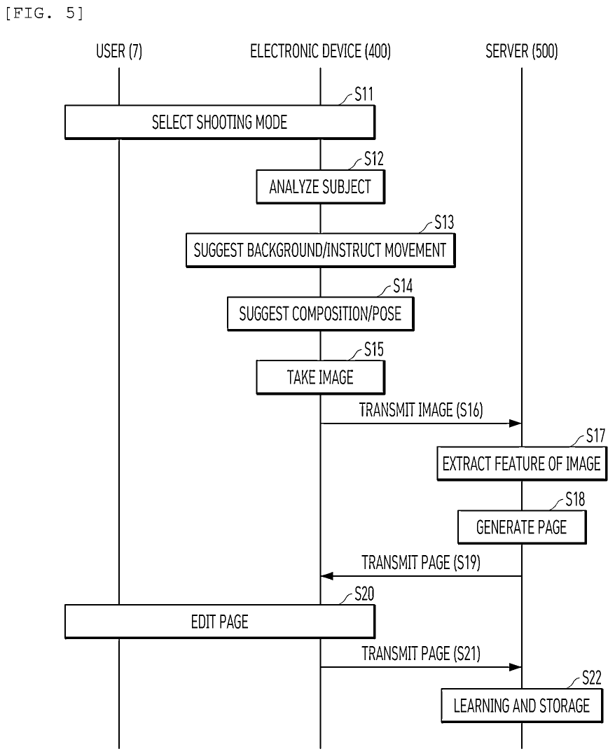

FIG. 5 is a flowchart for explaining the operation of the electronic device according to an embodiment.

Referring to FIG. 5, a user 7 may select a shooting mode through the electronic device 400 (S11). The user 7 may select the shooting mode by using a display or voice recognition. The user 7 may be the same as the subject 5, or may be a different individual entity. For example, the user 7 may take a picture of the subject 5 by operating the electronic device 400, and the subject 5 may serve as the user 7 of the electronic device 400 and operate the electronic device 400. The electronic device 400 may control at least one of the image sensor 410, the robot arm 420, and the moving part 470 according to the shooting mode. The shooting mode may be a fashion clothing shooting mode, a product shooting mode, a profile photo shooting mode, an ID photo shooting mode, a background photo shooting mode, and the like. The parameters of the image sensor 120 may include ISO sensitivity, shutter speed, exposure value (EV), focus, white balance (WB), and the like.

The electronic device 400 may analyze the subject 5 (S12). For example, when the subject 5 is a person, the electronic device 400 may analyze the body shape of the subject 5. The electronic device 400 may determine a background, a composition, a pose, and the like according to the body shape of the subject 5. When the subject 5 is an accessory such as a bag or a wallet, the electronic device 400 may learn which composition the subject 5 is most often taken in at a shopping mall or the like, and determine a background, a composition, and the like according to the learning result.

When the subject 5 is a person, the electronic device 400 may analyze the type of clothes worn by the subject 5. The electronic device 400 may determine a background, a composition, a pose, and the like according to the type of clothes worn by the subject 5. For example, when the subject 5 is wearing a top, the subject 5 may be taken with a composition centered on the upper body.

The electronic device 400 may suggest a background and/or a composition, and/or instruct the subject 5 to move (S13). The electronic device 400 may suggest a background suitable for the subject 5 or instruct movement to a specific location in a corresponding space based on the analysis in step S12. For example, the electronic device 400 may search for data on a shooting site where the electronic device 400 is located, and determine a background most suitable for the subject 5 based on the data. For example, the electronic device 400 may recognize the subject 5 who is a model wearing a one-piece through the image sensor 410, and suggest the subject 5 to move to a background suitable for taking a one-piece photo. As another example, in the case of ID photo shooting, the electronic device 400 may suggest a colorless background. In the case of food shooting, the electronic device 400 may suggest a background with a table. In the case of accessory shooting, the electronic device 400 may suggest a background of a desk, a shelf, and the like.

The electronic device 400 may suggest a plurality of backgrounds for various staging within the shooting site. For example, the electronic device 400 may instruct the subject 5 to move and be taken in the order of a horizon, a table, a sofa, and the like within the shooting site.

The electronic device 400 may suggest a composition and a pose (S14). In such a case, the electronic device 400 may use the display 430. The electronic device 400 may instruct the subject 5 to move to an exact location by using a laser pointer. The electronic device 400 may position the image sensor 410 to take a picture of the subject 5 with a set composition by using the robot arm 420. Based on the features of an image, the electronic device 400 may determine the position of the subject 5 and the proportion of the subject 5 in the image. That is, the electronic device 400 may determine an image by causing the subject 5 to occupy a certain position and a certain portion of the entire component of the image. In an embodiment, the electronic device 400 may correct the taken image based on the determined position and the determined proportion. In an embodiment, the electronic device 400 may instruct the subject 5 to move based on the determined position and the determined proportion, or may take a picture of the subject 5 after moving using the moving part.

The electronic device 400 may take an image of the subject 5 (S15). The electronic device 400 may take a picture of the subject 5 with the determined background, composition, and pose. The electronic device 400 may edit the image based on the features of the image. The editing may include adjusting image properties such as brightness, contrast, and saturation; inserting image filters; inserting frames; adding effects such as blur and mosaic; partial correction (distortion) such as face reduction, leg lengthening, and eye enlargement; cropping images; removing shadows; removing backgrounds (nuki); zooming in/out; adding text; pasting images, and the like. The image editing may be automatically performed by the artificial intelligence of the electronic device 400. The image may be edited by imitating the color sense of a specific photographer. For example, the electronic device 400 may perform training by using images taken by a specific photographer and image setting values as a training data set. The electronic device 400 may apply the image setting values of the specific photographer to the taken image. There may be a plurality of photographers, and the electronic device 400 may store different image setting values for each photographer.

The electronic device 400 may transmit the image to the server 500 (S16). The electronic device 400 may transmit the image by using the communication module 460.

The server 500 may extract features of the image (S17). The server 500 may extract feature points of each image and analyze the image based on the feature points. In an embodiment, the server 500 may edit the image based on the feature points of the image.

The server 500 may generate a page based on the features of the image (S18). For example, the server 500 may perform at least one operation among design generation, text generation, image editing, and image arrangement based on the features of the image.

The server 500 may transmit the generated page to the electronic device 400 (S19).

The user 7 may edit the page through the electronic device 400 (S20). When the user 7 edits the page through the electronic device 400, the server 500 may provide the electronic device 400 with an interface for editing the page. The interface may include menus such as AI template, theme color, photo, photo filter, character/body shape correction, thumbnail, and the like.

The electronic device 400 may transmit the edited page to the server 500 (S21).

The server 500 may learn the edited page and store the learned page in a database (S22).

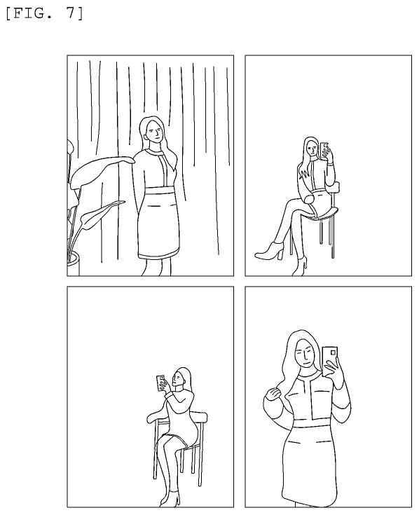

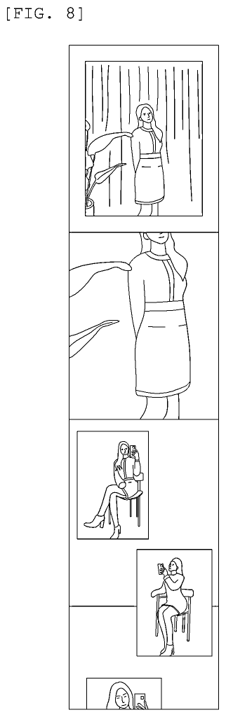

FIG. 6 is a diagram for explaining the operation of the controller according to an embodiment, FIG. 7 is an example of an image input to the controller according to an embodiment, and FIG. 8 is an example of an optimal page output by the controller according to an embodiment.

Referring to FIG. 6, the controller 300 may receive a plurality of images 30. The plurality of images 30 may include first to m^{th} images 30_1 to 30_m. Here, m may be an integer greater than 1. In an embodiment, the images received by the controller 300 may be as illustrated in FIG. 7. In such a case, m may be 4. The controller 300 may receive four images of FIG. 7 regardless of the order.

The controller 300 may analyze the plurality of images 30. That is, the controller 300 may extract features of each of the plurality of images 30. For example, the controller 300 may extract feature points of the first image 30_1, extract feature points of the second image 30_2, . . . , and extract feature points of the m^{th} image 30_m.

The controller 300 may extract common features of the plurality of images 30. For example, the controller 300 may determine properties commonly included in the feature points extracted from the first to m^{th} images 30_1 to 30_m. The controller 300 may determine a photo type defining the plurality of images 30 from the common properties.

In an embodiment, the controller 300 may determine that the first to m^{th} images 30_1 to 30_m are photos of a product (accessory, clothing, prop, and the like) being worn, from the common feature points of the first to m^{th} images 30_1 to 30_m. In such a case, the first to m^{th} images 30_1 to 30_m may all include the same or similar products. The similar products may mean products having the same shape but different colors, sizes, or the like.

In an embodiment, the controller 300 may determine that the first to m^{th} images 30_1 to 30_m are ID photos, from the common feature points of the first to m^{th} images 30_1 to 30_m. In such a case, the first to m^{th} images 30_1 to 30_m may all target only a person's face.

In an embodiment, the controller 300 may determine that the first to m^{th} images 30_1 to 30_m are natural photos, from the common feature points of the first to m^{th} images 30_1 to 30_m. In such a case, the first to m^{th} images 30_1 to 30_m may be images in which backgrounds such as the sea, mountain, forest, and the sky occupy most of the images and the proportion of people is a predetermined proportion or less.

According to the embodiment, the controller 300 may output the determined photo type to the electronic device 100 and receive a response from the electronic device 100. The response may be yes or no. The controller 300 may update the artificial intelligence model based on the response from the electronic device 100, the plurality of images 30, and the determined photo type.

When the plurality of images 30 include no common properties and are individual images having no relevance, the controller 300 may classify the plurality of images 30 based on the feature points of each of the plurality of images 30.

The controller 300 may edit the plurality of images 30 based on the feature points of each of the plurality of images 30. The editing may include adjusting image properties such as brightness, contrast, and saturation; inserting image filters; inserting frames; adding effects such as blur and mosaic; partial correction (distortion) such as face reduction, leg lengthening, and eye enlargement; cropping images; removing shadows; removing backgrounds (nuki); zooming in/out; adding text; pasting images, and the like.

For example, when the controller 300 determines that the plurality of images 30 are photos of a product being worn, the controller 300 may edit the plurality of images 30 so that an area occupied by the product in the plurality of images 30 exceeds a predetermined proportion. That is, the controller 300 may edit an image in which the area occupied by the product is a predetermined proportion or less. In an embodiment, when the predetermined proportion is 10% and the area occupied by the product in the first image 30_1 is 7%, the controller 300 may remove an unnecessary part from the first image 30_1 and enlarge the image so that the area occupied by the product exceeds 10%.

The controller 300 may determine the background part of the image as an unnecessary part. For example, the controller 300 may distinguish a human area from a non-human area in the image, and determine the non-human area as an unnecessary part. However, the present disclosure is not limited thereto, and when the image is a natural photo and the like, the controller 300 may be implemented to determine that the human area is an unnecessary part.

The controller 300 may add text based on the feature points of each of the plurality of images 30. For example, the text may include a clothing description, a sales phrase, and the like. The controller 300 may add text according to the classified image. For example, in the case of an image of a person wearing a pink one-piece dress, the controller 300 may add text such as ‘Sharara Pink One-piece Dress’ to the image description.

The controller 300 may generate a design based on the feature points of each of the plurality of images 30. For example, the design may include a shape, a layout, a color, and the like in which the plurality of images 30 are arranged. The controller 300 may determine and output a background color based on the color tone of the plurality of images 30. When the plurality of images 30 are images of a pink one-piece dress, the controller 300 may determine the background color as a pink tone and output the pink tone.

The controller 300 may arrange the plurality of images 30 based on the extracted feature points. For example, the controller 300 may arrange the plurality of images 30 based on the proportion of the subject in the image.

In an embodiment, the controller 300 may arrange the plurality of images 30 in an ascending order of the proportion of the subject. That is, the user may check an image in which the subject becomes increasingly larger as the user scrolls down the page. For example, when the image is a photo of a product being worn, the controller 300 may arrange plurality of images 30 in an ascending order.

In an embodiment, the controller 300 may arrange the plurality of images 30 in a descending order of the proportion of the subject. That is, the user may check an image in which the subject becomes increasingly smaller as the user scrolls down the page. For example, when the plurality of images 30 include different numbers of people, the controller 300 may arrange the plurality of images 30 in an order in which the number of people increasingly increases. That is, the proportion of one person in the image may increasingly decrease.

In addition, the controller 300 may arrange the plurality of images 30 based on a viewing angle in the image.

In an embodiment, the controller 300 may arrange the plurality of images 30 in an order in which the viewing angle decreases from top to bottom.

In an embodiment, the controller 300 may arrange the plurality of images 30 in an order in which the viewing angle moves from left to right. However, the present disclosure is not limited thereto, and the controller 300 may arrange the plurality of images 30 in different directions.

In addition, when the plurality of images 30 include different types of images, the controller 300 may arrange the plurality of images 30 based on the image type. For example, among the plurality of images 30, the first to m⁻¹ images 30_1 to 30_m−1 may be photos, and the m^{th} image 30_m may be a moving image. The controller 300 may preferentially arrange the first to m⁻¹ images 30_1 to 30_m−1 and arrange the m^{th} image last. Alternatively, the controller 300 may preferentially arrange the m^{th} image.

The controller 300 may adjust the color of each of the plurality of images 30 based on the extracted feature points. For example, the controller 300 may correct the plurality of images 30 with a most common color tone among colors included in each of the plurality of images 30. When the plurality of images 30 mainly include a blue color in common, the controller 300 may correct the plurality of images 30 in a way of emphasizing the blue color.

The controller 300 may generate an optimal page 50 from the plurality of images 30. In an embodiment, the optimal page generated by the controller 300 using the image of FIG. 7 may be as illustrated in FIG. 8.

When generating the optimal page 50, the controller 300 may acquire and arrange data associated with the plurality of images 30. The data may be text, images, sound, and the like. In such a case, the controller 300 may use a crawling function. The crawling function may refer to a function of collecting websites, hyperlinks, data, information resources, and the like. The controller 300 may assign an identifier to each collected data and store the data in a database.

Optionally, the controller 300 may acquire image information from the electronic device 100. The electronic device 100 may input image information together with the plurality of images 30. For example, the electronic device 100 may transmit the plurality of images 30 to the controller 300 and inform the controller 300 that the plurality of images 30 are photos of a product being worn. Accordingly, the controller 300 may acquire data related to the product from the database and arrange the data together with the plurality of images 30.

For example, when the second image 30_2 is an image of a pink one-piece dress, the controller 300 may acquire data about the product from the database. The controller 300 may acquire enlarged photos (neckline, accessories, finishing, and the like) of the pink one-piece dress, fabric photos, blended information, washing instructions, size, sense of thickness, sense of fit, other composition photos, photos of other users wearing the dress, keywords searched together, related search terms, and the like from the database.

The controller 300 may determine compositions of the plurality of images 30 and acquire photos of compositions not present in the plurality of images 30. For example, when the plurality of images 30 include only product images, the controller 300 may acquire images of models wearing the dress, images of actual users wearing the dress, and the like and arrange the images together with the plurality of images 30. When the plurality of images 30 are partial images, the controller 300 may acquire full images and arrange the acquired full images together with the plurality of images 30.

The controller 300 may arrange the acquired data together with the second image 30_2. For example, the controller 300 may arrange text such as ‘Sharara One Piece’ and ‘Cherry Blossom Play One Piece’ together with the second image 30_2, and arrange a pink-toned image such as a cherry blossom image in the background.

In addition, when the third image 30_3 is an image related to a winter jumper, the controller 300 may arrange text such as ‘Midwinter Coat’ and ‘Stove Padding’ together with the third image 30_3, arrange an animation image of snow falling in the background, and output an effect similar to duck feathers being spewed out.

The controller 300 may perform training by using the plurality of images 30 and the generated optimal page 50 as training data. The controller 300 may update the artificial intelligence model according to the training result.

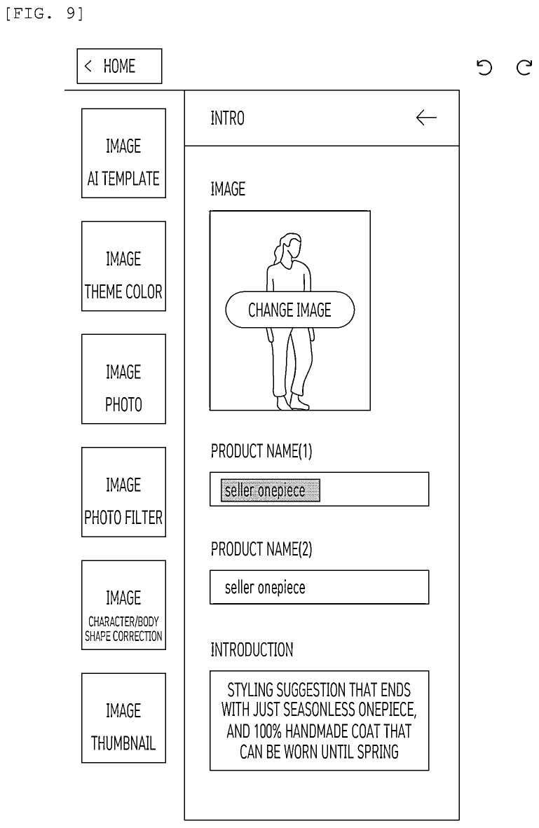

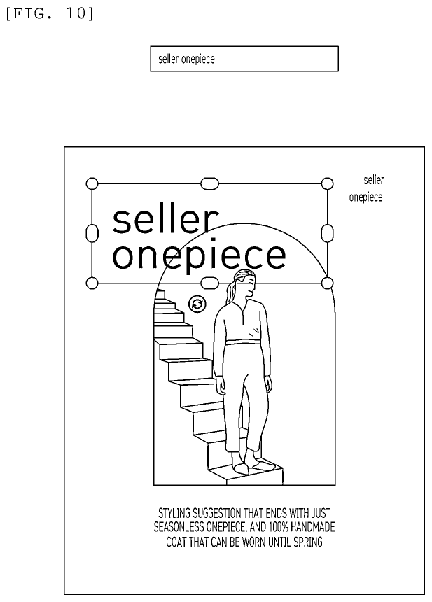

FIG. 9 is an example of an edit page output by the controller according to an embodiment, and FIG. 10 is an example of an edit page output by the controller according to an embodiment.

Referring to FIGS. 9 and 10, the controller 300 may provide an interface to the electronic device 100 so that the generated optimal page 50 may be corrected. The interface may include menus such as AI template, theme color, photo, photo filter, character/body shape correction, and thumbnail. Accordingly, the user may easily correct the optimal page 50. The controller 300 may perform an auxiliary operation when the user corrects the optimal page 50.

The user may not like the style (feminine, romantic, and the like) recommended by the controller 300. In such a case, the controller 300 may receive a change request from the electronic device 100, and the controller 300 may recommend another template. The user may change the entire design of the optimal page 50 with one click by using the electronic device 100.

The controller 300 may receive a request to correct a product name and an introduction from the electronic device 100. Based on the request, the controller 300 may recommend a suitable product name and keywords well exposed on a search platform. The controller 300 may also recommend the size, style, and layout of the product name and the introduction.

The user may intend to change the position of the image on the optimal page 50. That is, the controller 300 may receive a request to change the position of the image from the electronic device 100. The controller 300 may also change the arrangement of other photos by recognizing the user's intention. For example, the controller 300 may receive images of products with two colors A and B. When the electronic device 100 moves B ahead of A, the controller 300 may change the entire text content and the positions of the images with priority given to B.

The controller 300 may receive a keyword from the electronic device 100. The keyword may be a keyword related to the product name or the introduction. The controller 300 may recommend text suitable for the keyword. For example, when a keyword ‘sleeveless’ is received from the electronic device 100, the controller 300 may output text such as ‘sleeveless that can be worn coolly in the summer’. The electronic device 100 may use as is, correct, or not use the text output by the controller 300.

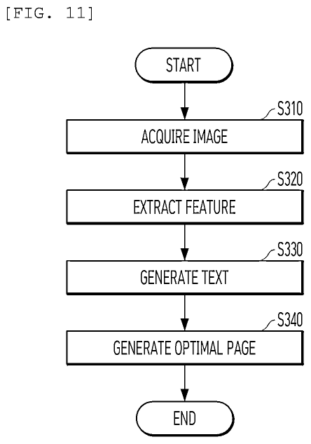

FIG. 11 is a flowchart of a page output method according to an embodiment.

Referring to FIG. 11, the page output method according to an embodiment may be performed by an electronic device. The page output method according to an embodiment may output a page for a seller. The electronic device may perform machine learning, including the artificial intelligence model. The electronic device may be the controller included in the server.

The electronic device may acquire an image (S310). The image may include photos, moving pictures, and the like. The moving pictures may include continuous images taken by a camera and images generated by connecting together a plurality of non-continuous photos. The electronic device may receive a plurality of images. In such a case, the plurality of images may be related to each other or may be individual images that are not related to each other.

The electronic device may extract features of the image (S320). The electronic device may extract the features of the image by analyzing the image. For example, the electronic device may extract feature points of the image and determine the photo type of the image. The photo type may be an ID photo, a product photo, a nature photo, and the like.

When there are a plurality of images, the electronic device may extract common features of the plurality of images. Based on the common features, the electronic device may perform an operation such as determining that the plurality of images include a common product or determining that the plurality of images are all ID photos.

The electronic device may generate an optimal page including the image (S330). The electronic device may generate the optimal page based on the features of the image. For example, the electronic device may perform at least one operation among design generation, text generation, image editing, and image arrangement based on the features of the image. The electronic device may provide the generated optimal page to a user.

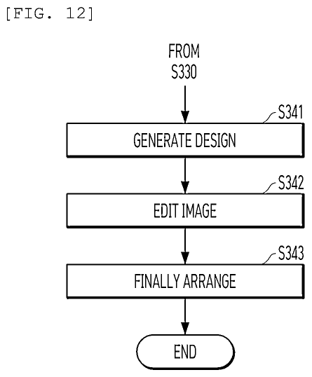

FIG. 12 is a flowchart of a page output method according to an embodiment.

Referring to FIG. 12, the electronic device according to an embodiment may extract the features of the image (S320) and then generate a design (S341). For example, the design may include a shape, a layout, a color, and the like. When the electronic device receives a plurality of images, the electronic device may determine properties commonly included in the plurality of images from the extracted features. The electronic device may generate a design based on the common properties of the plurality of images.

The electronic device may generate text (S330). The electronic device may generate the text based on the features of the image. For example, when the image is about ‘sleeveless’, the electronic device may generate text such as ‘sleeveless that can be worn coolly in the summer’ and arrange the text near the image.

The electronic device may edit the image (S342). The editing may include adjusting image properties such as brightness, contrast, and saturation; inserting image filters; inserting frames; adding effects such as blur and mosaic; partial correction (distortion) such as face reduction, leg lengthening, and eye enlargement; cropping images; removing shadows; removing backgrounds (nuki); zooming in/out; adding text; pasting images, and the like. When the plurality of images are images of the same product, the electronic device may edit the images so that the proportion of a product in the image exceeds a predetermined proportion.

The electronic device may finally arrange the images (S343). The electronic device may arrange the images according to the features of the plurality of images. For example, the electronic device may arrange the plurality of images based on the proportion of a subject. The electronic device may arrange the plurality of images based on a viewing angle. The electronic device may arrange the plurality of images based on an image type.

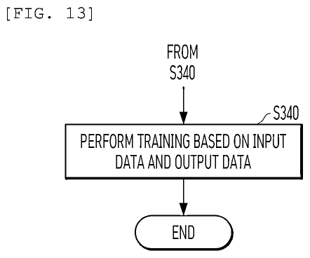

FIG. 13 is a flowchart of a page output method according to an embodiment.

Referring to FIG. 13, the electronic device according to an embodiment may generate the optimal page (S330) and then perform training based on input data and output data (S340). The electronic device may update the artificial intelligence model. When a plurality of images are subsequently received, the electronic device may generate an optimal page by using the updated artificial intelligence model.

FIG. 14 is a diagram for explaining the operation of the controller according to an embodiment.

Referring to FIG. 14, the controller 300 may receive a plurality of pieces of information data 70. The plurality of pieces of information data 70 may include first to n^{th} information data 70_1 to 70_n. Here, n may be an integer greater than 1. The information data 70_1 to 70_n may each include user information and/or environmental information. Depending on the embodiment, the user information and/or environmental information may also have been stored in a database.

The user information may include personal information such as gender and age, and information on purchase history, search history, access country, access device, and the like. The user information may have been stored in the electronic device as log data.

The environmental information may include information on time-series environments such as season (S/S, F/F, and the like), season, time, and day of the week.

The controller 300 may analyze the plurality of pieces of information data 70. That is, the controller 300 may extract features of each of the plurality of pieces of information data 70. For example, the controller 300 may extract feature points of the first information data 70_1, extract feature points of the second information data 70_2, . . . , and extract feature points of the nth information data 70_n.

The controller 300 may generate an optimal page 90 based on the extracted features. The optimal page 90 may be a page responding to a user request. That is, the controller 300 may generate the optimal page 90 including information optimized for the user information and/or environmental information while outputting a page corresponding to the user request.

For example, a first user may access the server 200 by using a first electronic device. The first user may search the server 200 for ‘guest coordination’. In such a case, the controller 300 of the server 200 may determine a guest look with neat and unobtrusive colors and designs based on the user information and/or environmental information of the first user, and recommend the determined guest look to the first user. In such a case, the controller 300 may output text such as “We recommend a guest look with neat and unobtrusive colors and designs” to the first user. When the current season is summer, the controller 300 may recommend a neat and calm colored short-sleeved one-piece dress to the first user.

A second user may access the server 200 by using a second electronic device. The second user may search the server 200 for ‘date look’. In such a case, the controller 300 may determine a one-piece dress that gives a pure feeling with a neat date look based on the user information and/or environmental information of the second user, and recommend the determined one-piece dress to the second user. In such a case, the controller 300 may output text such as “This is a one-piece dress that gives a pure feeling with a neat date look” to the second user. Even in the case of the same product, the controller 300 may output different text depending on the user's purpose and the like. The method by which the controller 300 outputs text is not limited to a format such as voice, image, and text.

Based on the plurality of pieces of information data 70, the controller 300 may output information that the user may be interested in. The information that the user may be interested in may include products sold a lot to users similar to the user on a shopping site, products similar to products searched by the user, and the like.

In an embodiment, based on a result of analyzing the plurality of pieces of information data 70, the controller 300 may determine that the user is a female in her teens to 20s. The controller 300 may arrange a short-form video at the top of the page. The controller 300 may reduce the number of texts and move a female fitting photo to the top.

In an embodiment, based on a result of analyzing the plurality of pieces of information data 70, the controller 300 may determine that the user is a male in his 40s to 50s. The controller 300 may enlarge the size of text and images and increase the number of texts. The controller 300 may move a male fitting photo to the top.

The controller 300 may provide the user with the optimal page 90. The controller 300 may train the artificial intelligence model by using at least one of the user information, the environmental information, and the optimal page.

FIG. 15 is a flowchart of a page output method according to an embodiment.

Referring to FIG. 15, the page output method according to an embodiment may be performed by the electronic device. The page output method according to an embodiment may output a page for a purchaser. The electronic device may perform machine learning, including the artificial intelligence model. The electronic device may be the controller included in the server.

The electronic device may acquire user information (S1110).

The user information may include personal information such as gender and age, and information on purchase history, search history, access country, access device, and the like. The user information may have been stored in the electronic device as log data.

The electronic device may acquire environmental information (S1120).

The environmental information may include information on time-series environments such as season (S/S, F/F, and the like), season, time, and day of the week.

The electronic device may generate an optimal page based on the user information and environmental information (S1130). The optimal page may be a page responding to a user request. That is, the electronic device may generate a page to include information optimized for the user information and/or environmental information while outputting a page corresponding to the user request.

The electronic device may acquire text and images according to the user request, and arrange the text and images based on the user information and environmental information.

For example, the electronic device may output information that the user may be interested in on a page. The information that the user may be interested in may include products sold a lot to users similar to the user on a shopping site, products similar to products searched by the user, and the like.

The electronic device may train the artificial intelligence model by using at least one of the user information, the environmental information, and the optimal page as training data.

In some embodiments, each component or a combination of two or more components described with reference to FIGS. 1 to 15 may be implemented as a digital circuit, a programmable or non-programmable logic device or array, an application specific integrated circuit (ASIC), and the like.

Although the embodiments of the present invention have been described in detail above, the scope of the present invention is not limited thereto, and various modifications and improvements made by those skilled in the art using the basic concept of the present invention defined in the following claims are included in the scope of the present disclosure.

### Mode for Implementing the Invention

The mode for implementing the invention has been described together with the best mode for implementing the invention above.

### INDUSTRIAL APPLICABILITY

The present disclosure relates to an electronic device and a method for taking a picture thereof, and has repeatability and industrial applicability in electronic devices for performing shooting.

What is claimed is:

1. A method for taking a picture, comprising:
a step of acquiring a first image of a subject;
a step of determining a background and a composition based on the first image; and
a step of acquiring a second image of the subject by taking a picture of the subject with the background and the composition.

2. The method for taking a picture of claim 1, further comprising:
a step of acquiring a shooting mode,
wherein the step of acquiring the first image comprises a step of acquiring the first image according to the shooting mode,
the step of acquiring the second image comprises a step of acquiring the second image according to the shooting mode, and
the shooting mode is any one of a fashion clothing shooting mode, a product shooting mode, a profile photo shooting mode, an ID photo shooting mode, and a background photo shooting mode.

3. The method for taking a picture of claim 1, wherein the step of determining the background and the composition comprises:
a step of extracting a feature of the first image; and
a step of determining a background and a composition corresponding to the feature of the first image from a database.

4. The method for taking a picture of claim 3, wherein the step of determining the background and the composition comprises:
a step of acquiring a plurality of images from the database;
a step of acquiring backgrounds and compositions of the plurality of images;
a step of training an artificial neural model by using the plurality of images and the backgrounds and compositions of the plurality of images as a training set; and
a step in which the artificial neural model determines the background and the composition based on the first image.

5. The method for taking a picture of claim 3, wherein the step of determining the background and the composition comprises:
a step of extracting a feature of the first image; and
a step of determining a position and a proportion of the subject in the image from the database based on the feature of the first image.

6. The method for taking a picture of claim 1, further comprising:
a step of determining a pose based on the first image when the first image comprises a person.

7. The method for taking a picture of claim 6, wherein the step of determining the pose comprises:
a step of acquiring a body shape of the person based on the first image; and
a step of determining a pose corresponding to the body shape.

8. The method for taking a picture of claim 6, further comprising:
a step of determining a similarity between the person and the pose; and
a step of taking a picture of the subject when the similarity exceeds a reference value and outputting a notification message when the similarity is below the reference value.

9. The method for taking a picture of claim 1, further comprising:
a step of extracting a feature of the second image; and
a step of generating a page based on the feature of the second image.

10. An electronic device comprising:
an image sensor configured to acquire a first image of a subject; and
a processor configured to determine a background and a composition based on the first image,
wherein the image sensor is further configured to acquire a second image of the subject by taking a picture of the subject with the background and the composition.

11. The electronic device of claim 10, further comprising:
a robot arm disposed with the image sensor and driven according to a command of the processor,
wherein the processor is further configured to perform training by using an image taken by a specific photographer, a composition, a shooting position, and a distance to the subject as a training data set, and control the robot arm to take an image with the composition and the shooting position of the specific photographer and the distance to the subject when a specific photographer mode is input.

12. The electronic device of claim 10, wherein the processor is further configured to perform training by using the image taken by a specific photographer and an image setting value as a training data set, and
edit the first image and the second image by applying the image setting value.

13. The electronic device of claim 10, wherein the processor is further configured to acquire a shooting mode,
the image sensor is further configured to acquire the first image according to the shooting mode and acquire the second image according to the shooting mode, and
the shooting mode is any one of a fashion clothing shooting mode, a product shooting mode, a profile photo shooting mode, an ID photo shooting mode, and a background photo shooting mode.

14. The electronic device of claim 10, wherein the processor is further configured to extract a feature of the first image and determine a background and a composition corresponding to the feature of the first image from a database.

15. The electronic device of claim 14, wherein the processor is further configured to acquire a plurality of images from the database, acquire backgrounds and compositions of the plurality of images, train an artificial neural model by using the plurality of images and the backgrounds and compositions of the plurality of images as a training set, and allow the artificial neural model to determine the background and the composition based on the first image.

16. The electronic device of claim 15, further comprising:
a moving part driven according to a command of the processor,
wherein the processor is further configured to determine a similarity between the subject and the background and the composition of the trained image, take a picture of the subject when the similarity exceeds a reference value, and instruct the moving part to move when the similarity is below the reference value.

17. The electronic device of claim 10, wherein the processor is further configured to extract a feature of the first image and determine a position and a proportion of the subject in the image from a database based on the feature of the first image.

18. The electronic device of claim 10, wherein the processor is further configured to determine a pose based on the first image when the first image comprises a person.

19. The electronic device of claim 18, wherein the processor is further configured to acquire a body shape of the person based on the first image and determine a pose corresponding to the body shape.

20. The electronic device of claim 18, wherein the processor is further configured to determine a similarity between the person and the pose, take a picture of the subject when the similarity exceeds a reference value, and output a notification message when the similarity is below the reference value.

21. The electronic device of claim 10, wherein the processor is further configured to extract a feature of the second image and generate a page based on the feature of the second image.
